(19) United States
(12) Patent Application Publication
(10) Pub. No.: US 2018/0326905 A1
(43) Pub. Date: Nov. 15, 2018

(54) ON-VEHICLE APPARATUS, ALERT OUTPUT METHOD, AND COMPUTER READABLE MEDIUM

(71) Applicant: Mitsubishi Electric Corporation, Tokyo (JP)

(72) Inventors: Yusuke NAKATA, Tokyo (JP); Yuka FUJITA, Tokyo (JP)

(73) Assignee: Mitsubishi Electric Corporation, Tokyo (JP)

(21) Appl. No.: 15/775,290

(22) PCT Filed: Mar. 11, 2016
(86) PCT No.: PCT/JP2016/057819

§ 371 Date: May 10, 2018

(51) Int. Cl. B60Q 9/00; G06K 9/00; H04N 5/247; G06T 7/20

(52) U.S. Cl. CPC B60Q 9/008; G06K 9/00845; H04N 5/247; B60Q 1/34; G06T 7/20; G06K 9/00604; G06K 9/00825

(57) ABSTRACT

A monitoring unit monitors action of a driver of a preceding adjacent vehicle and a lighting-up state of a turn signal of the preceding adjacent vehicle, using a photographed image showing the preceding adjacent vehicle, and instructs to output an alert to a driver of a vehicle when the monitoring unit detects lighting up of the turn signal without detecting the driver of the preceding adjacent vehicle taking safety check action for a lane change to a travel lane, the preceding adjacent vehicle traveling preceding the vehicle in the same direction as a travel direction of the vehicle and in a lane adjacent to the travel lane, the travel lane being a lane in which the vehicle is traveling, and the lighting up of the turn signal giving notice of a lane change to the travel lane. An alert output unit outputs the alert based on an instruction from the monitoring unit.

### TECHNICAL FIELD

The present invention relates to an on-vehicle apparatus.

In the following, a lane in which a given vehicle is traveling is referred to as travel lane. In addition, a vehicle that travels preceding the vehicle in the same direction as a travel direction of the vehicle and in a lane adjacent to the travel lane is referred to as preceding adjacent vehicle.

### BACKGROUND ART

When a preceding adjacent vehicle makes a lane change to the travel lane, if a driver of the preceding adjacent vehicle neglects turn signal indication or a visual check, then the preceding adjacent vehicle may collide with the vehicle. To prevent such a collision accident, there are techniques in which a device mounted on the preceding adjacent vehicle senses whether a driver of the preceding adjacent vehicle has taken side and rear safety check action, and gives notice to the outside of the preceding adjacent vehicle as to whether safety check action has been taken, using a display mounted on the rear of the preceding adjacent vehicle or vehicle-to-vehicle communication (e.g., Patent Literatures 1 and 2).

### CITATION LIST

### Patent Literature

Patent Literature 1: JP 2014-97456 A

Patent Literature 2: JP 2015-222421 A

### SUMMARY OF INVENTION

### Technical Problem

Techniques of Patent Literatures 1 and 2 depend on the device mounted on the preceding adjacent vehicle. Hence, when the device is not mounted on the preceding adjacent vehicle, a driver of a vehicle diagonally behind the preceding adjacent vehicle cannot expect that the preceding adjacent vehicle makes a lane change without safety check action. Therefore, if the preceding adjacent vehicle makes a lane change without safety check action in a situation in which the preceding adjacent vehicle and the vehicle diagonally behind the preceding adjacent vehicle are traveling close to each other, the driver of the vehicle diagonally behind the preceding adjacent vehicle cannot take collision avoidance action, causing a collision accident. As described above, since the techniques of Patent Literatures 1 and 2 depend on the device mounted on the preceding adjacent vehicle, there is a problem that a collision accident associated with a lane change by the preceding adjacent vehicle cannot be effectively prevented.

One of the main objects of the invention is to solve problems such as that described above, and the main object of the invention is to effectively prevent a collision accident associated with a lane change by a preceding adjacent vehicle.

### Solution to Problem

An on-vehicle apparatus mounted on a vehicle according to the present invention, includes:

a monitoring unit to monitor action of a driver of a preceding adjacent vehicle and a lighting-up state of a turn signal of the preceding adjacent vehicle, using a photographed image showing the preceding adjacent vehicle, and instruct to output an alert to a driver of the vehicle, when detecting lighting up of the turn signal without detecting the driver of the preceding adjacent vehicle taking safety check action for a lane change to a travel lane, the preceding adjacent vehicle traveling preceding the vehicle in a same direction as a travel direction of the vehicle and in a lane adjacent to the travel lane, the travel lane being a lane in which the vehicle is traveling, and the lighting up of the turn signal giving notice of a lane change to the travel lane; and

an alert output unit to output the alert based on an instruction from the monitoring unit.

### Advantageous Effects of Invention

In the present invention, action of a driver of a preceding adjacent vehicle and a lighting-up state of a turn signal of the preceding adjacent vehicle are monitored, using a photographed image. Then, in the present invention, when lighting up of the turn signal that gives notice of a lane change to a travel lane is detected without detecting the driver of the preceding adjacent vehicle taking safety check action for a lane change to the travel lane, an alert to a driver of a vehicle is outputted. Hence, according to the present invention, a driver of a vehicle diagonally behind a preceding adjacent vehicle can recognize a possibility that the preceding adjacent vehicle may make a lane change without a safety check, and thus, a collision accident associated with a lane change by the preceding adjacent vehicle can be effectively prevented.

### BRIEF DESCRIPTION OF DRAWINGS

FIG. 1 is a diagram illustrating an exemplary hardware configuration of a vehicle apparatus according to a first to a fourth embodiment.

FIG. 2 is a diagram illustrating an exemplary functional configuration of an on-vehicle apparatus according to the first embodiment.

FIG. 3 is a flowchart diagram illustrating exemplary operation of the on-vehicle apparatus according to the first embodiment.

FIG. 4 is a flowchart diagram illustrating exemplary operation of the on-vehicle apparatus according to the first embodiment.

FIG. 5 is a flowchart diagram illustrating exemplary operation of an on-vehicle apparatus according to the second embodiment.

FIG. 6 is a flowchart diagram illustrating exemplary operation of the on-vehicle apparatus according to the second embodiment.

FIG. 7 is a diagram illustrating an exemplary functional configuration of an on-vehicle apparatus according to the third embodiment.

FIG. 8 is a flowchart diagram illustrating exemplary operation of the on-vehicle apparatus according to the third embodiment.

FIG. 9 is a diagram illustrating an exemplary functional configuration of an on-vehicle apparatus according to the fourth embodiment.

FIG. 10 is a flowchart diagram illustrating exemplary operation of the on-vehicle apparatus according to the fourth embodiment.

### DESCRIPTION OF EMBODIMENTS

### First Embodiment

Description of Configuration

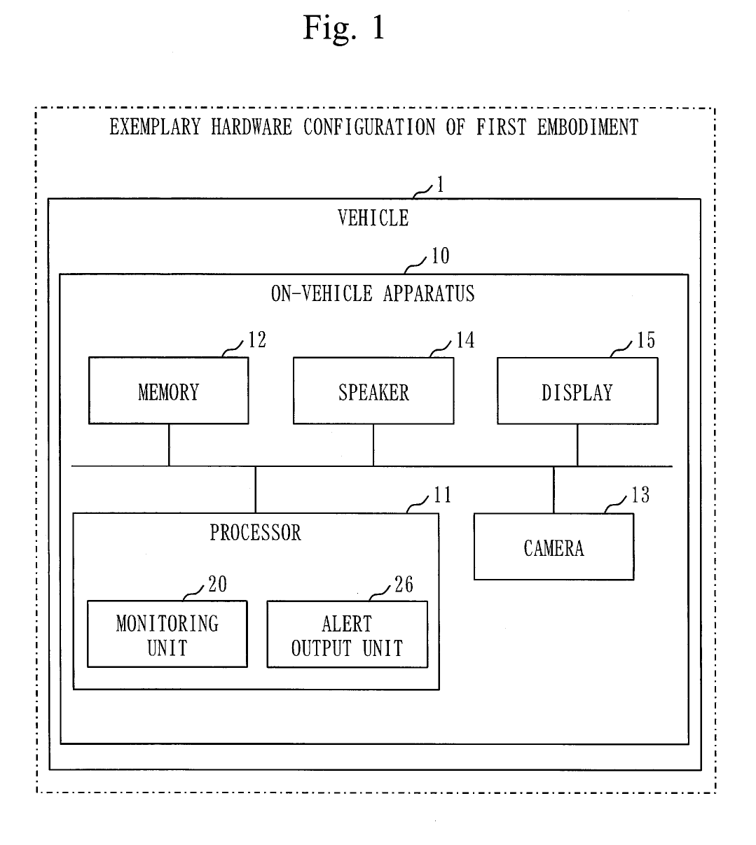

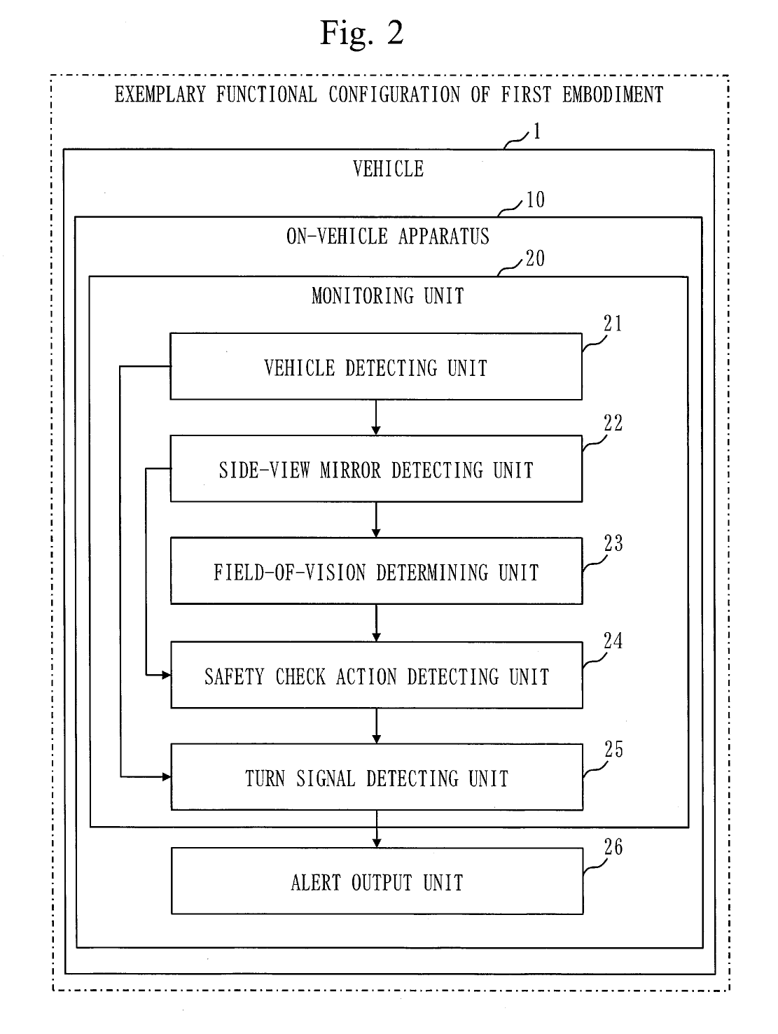

FIG. 1 illustrates an exemplary hardware configuration of an on-vehicle apparatus 10 according to the present embodiment. FIG. 2 illustrates an exemplary functional configuration of the on-vehicle apparatus 10 according to the present embodiment. Operation performed by the on-vehicle apparatus 10 corresponds to an alert output method and an alert output program.

As illustrated in FIGS. 1 and 2, the on-vehicle apparatus 10 is mounted on a vehicle 1.

First, with reference to FIG. 1, an exemplary hardware configuration of the on-vehicle apparatus 10 will be described.

The on-vehicle apparatus 10 is a computer, and is composed of a processor 11, a memory 12, a camera 13, a speaker 14, and a display 15.

The processor 11 executes programs.

The memory 12 stores therein programs that implement the functions of a monitoring unit 20 and an alert output unit 26 which are illustrated in FIG. 2.

Then, the processor 11 executes the programs and performs the operation of the monitoring unit 20 and the alert output unit 26 which will be described later.

The camera 13 is installed in a position in which the camera 13 can photograph an area in front of the vehicle 1, and photographs the area in front of the vehicle 1. In the present embodiment, the camera 13 is installed near a rear-view mirror.

The speaker 14 presents a driver of the vehicle 1 an alert by audio.

The display 15 presents the driver of the vehicle 1 an alert by characters and graphics.

Next, an exemplary functional configuration of FIG. 2 will be described.

The on-vehicle apparatus 10 according to the present embodiment is composed of the monitoring unit 20 and the alert output unit 26.

In addition, the monitoring unit 20 is composed of a vehicle detecting unit 21, a side-view mirror detecting unit 22, a field-of-vision determining unit 23, a safety check action detecting unit 24, and a turn signal detecting unit 25.

Description of Operation

Next, exemplary operation of the monitoring unit 20 and the alert output unit 26 illustrated in FIG. 2 will be described.

The monitoring unit 20 monitors the action of a driver of a preceding adjacent vehicle and the lighting-up state of a turn signal of the preceding adjacent vehicle, using a photographed image of the camera 13. The preceding adjacent vehicle is a vehicle that travels preceding the vehicle 1 in the same direction as a travel direction of the vehicle 1 and in a lane adjacent to a travel lane which is a lane in which the vehicle 1 is traveling. The photographed image of the camera 13 shows the preceding adjacent vehicle.

When the monitoring unit 20 has detected the lighting up of a turn signal that gives notice of a lane change to the travel lane, without detecting the driver of the preceding adjacent vehicle taking safety check action for a lane change to the travel lane, the monitoring unit 20 instructs the alert output unit 26 to output an alert to the driver of the vehicle 1.

In addition, the monitoring unit 20 determines whether the eyes of the driver of the preceding adjacent vehicle are reflected in a side-view mirror of the preceding adjacent vehicle shown in the photographed image, the side-view mirror being closer to the travel lane. Then, when the monitoring unit 20 has detected the lighting up of the turn signal that gives notice of a lane change to the travel lane with the eyes of the driver of the preceding adjacent vehicle not reflected in the side-view mirror, the monitoring unit 20 instructs the alert output unit 26 to output an alert.

In addition, the monitoring unit 20 determines whether the driver of the preceding adjacent vehicle has taken safety check action for a lane change to the travel lane, by analyzing the movement of the eyes of the driver of the preceding adjacent vehicle reflected in the side-view mirror, with the eyes of the driver of the preceding adjacent vehicle reflected in the side-view mirror. That is, when the eyes of the driver of the preceding adjacent vehicle reflected in the side-view mirror are directed to the side-view mirror, the monitoring unit 20 determines that the driver of the preceding adjacent vehicle has taken safety check action for a lane change to the travel lane.

The alert output unit 26 outputs an alert to the driver of the vehicle 1 to the speaker 14 or the display 15, based on an instruction from the monitoring unit 20. The alert output unit 26 outputs, by audio, a message notifying that there is a possibility that the preceding adjacent vehicle may make an unsafe lane change, to the speaker 14. In addition, the alert output unit 26 outputs, by characters or graphics or by characters and graphics, a message notifying that there is a possibility that the preceding adjacent vehicle may make an unsafe lane change, to the display 15. The alert output unit 26 may output an alert to both the speaker 14 and the display 15.

In addition, the alert output unit 26 can also notify the driver of the vehicle 1 of the possibility that the preceding adjacent vehicle may make an unsafe lane change, by methods other than audio, characters, and graphics. For example, the alert output unit 26 can also notify the driver of the vehicle 1 of the possibility that the preceding adjacent vehicle may make an unsafe lane change, by vibrating a part of a vehicle body.

Next, the operation of each of the vehicle detecting unit 21, the side-view mirror detecting unit 22, the field-of-vision determining unit 23, the safety check action detecting unit 24, and the turn signal detecting unit 25 which are included in the monitoring unit 20 will be described.

The vehicle detecting unit 21 selects candidate vehicles for a preceding adjacent vehicle by image processing performed on a photographed image of the camera 13, and detects a preceding adjacent vehicle from among the selected candidate vehicles.

For an image processing method for selecting candidate vehicles for a preceding adjacent vehicle, any publicly known method can be used. As an example, the vehicle detecting unit 21 can use a template matching method. In addition, for an image processing method for detecting a preceding adjacent vehicle from among candidate vehicles, too, any publicly known method can be used. As an example, the vehicle detecting unit 21 can detect a preceding adjacent vehicle by identifying a travel lane and a lane adjacent to the travel lane by sensing a white line.

In addition, after detecting a preceding adjacent vehicle, the vehicle detecting unit 21 extracts a region in the photographed image that shows the preceding adjacent vehicle.

The side-view mirror detecting unit 22 detects a side-view mirror installed on the preceding adjacent vehicle. More specifically, one of two side-view mirrors of the preceding adjacent vehicle that is closer to the travel lane is detected by image processing performed on the image of the preceding adjacent vehicle which is extracted by the vehicle detecting unit 21. That is, when the vehicle 1 is traveling on an adjacent lane on the right side of the lane for the preceding adjacent vehicle, the side-view mirror detecting unit 22 detects a right side-view mirror. On the other hand, when the vehicle 1 is traveling on an adjacent lane on the left side of the lane for the preceding adjacent vehicle, the side-view mirror detecting unit 22 detects a left side-view mirror. Then, the side-view mirror detecting unit 22 extracts a region in the image of the preceding adjacent vehicle that shows the detected side-view mirror. Note that for an image processing method for detecting a side-view mirror, any publicly known technique can be used. As an example, the side-view mirror detecting unit 22 can use a template matching method.

The field-of-vision determining unit 23 determines whether the vehicle 1 is present in the field of vision of the driver of the preceding adjacent vehicle. When the driver of the preceding adjacent vehicle can visually recognize the vehicle 1 through the side-view mirror of the preceding adjacent vehicle, the vehicle 1 can also visually recognize the eyes of the driver of the preceding adjacent vehicle through the side-view mirror of the preceding adjacent vehicle. Hence, the field-of-vision determining unit 23 determines whether the eyes of the driver of the preceding adjacent vehicle can be detected in the side-view mirror of the preceding adjacent vehicle, by image processing performed on the image of the side-view mirror which is detected by the side-view mirror detecting unit 22. Then, when the field-of-vision determining unit 23 has been able to detect the eyes of the driver of the preceding adjacent vehicle, the field-of-vision determining unit 23 determines that the vehicle 1 is present in the field of vision of the driver of the preceding adjacent vehicle. For an image processing method for detecting the eyes of the driver of the preceding adjacent vehicle, any publicly known technique can be used. As an example, the field-of-vision determining unit 23 can use a template matching method.

The safety check action detecting unit 24 detects side and rear safety check action by the driver of the preceding adjacent vehicle. More specifically, the safety check action detecting unit 24 detects that the eyes of the driver of the preceding adjacent vehicle are directed to the side-view mirror, by image processing performed on the image of the side-view mirror which is extracted by the side-view mirror detecting unit 22. The safety check action detecting unit 24 can detect both the directing of only the line of sight of the driver of the preceding adjacent vehicle to the side-view mirror without moving his/her face and the directing of the line of sight of the driver of the preceding adjacent vehicle to the side-view mirror by moving his/her face, by image processing performed on the image of the side-view mirror. When the safety check action detecting unit 24 has been able to detect that the eyes of the driver of the preceding adjacent vehicle are directed to the side-view mirror, the safety check action detecting unit 24 determines that the driver of the preceding adjacent vehicle has taken safety check action for a lane change. For an image processing method for detecting the movement of the eyes of the driver of the preceding adjacent vehicle, any publicly known technique can be used. Specifically, the safety check action detecting unit 24 can estimate the line of sight by a template matching method or from a positional relationship between facial feature points and irises.

The turn signal detecting unit 25 determines the intention of the driver of the preceding adjacent vehicle for a lane change, by detecting the lighting up of a turn signal of the preceding adjacent vehicle. The turn signal detecting unit 25 detects the lighting up of a turn signal of the preceding adjacent vehicle by image processing performed on the image of the preceding adjacent vehicle which is extracted by the vehicle detecting unit 21. The turn signal detecting unit 25 detects the lighting up of a right turn signal when the vehicle 1 is traveling in a lane on the right side of the preceding adjacent vehicle, and detects the lighting up of a left turn signal when the vehicle 1 is traveling in a lane on the left side. For an image processing technique, any publicly known technique can be used. Specifically, the turn signal detecting unit 25 can use a template matching method.

When the turn signal detecting unit 25 has detected the lighting up of a turn signal with safety check action not detected by the safety check action detecting unit 24, the turn signal detecting unit 25 determines that it is highly likely that the driver of the preceding adjacent vehicle makes a lane change to the travel lane with the driver of the preceding adjacent vehicle not visually recognizing the vehicle 1, and thus instructs the alert output unit 26 to output an alert.

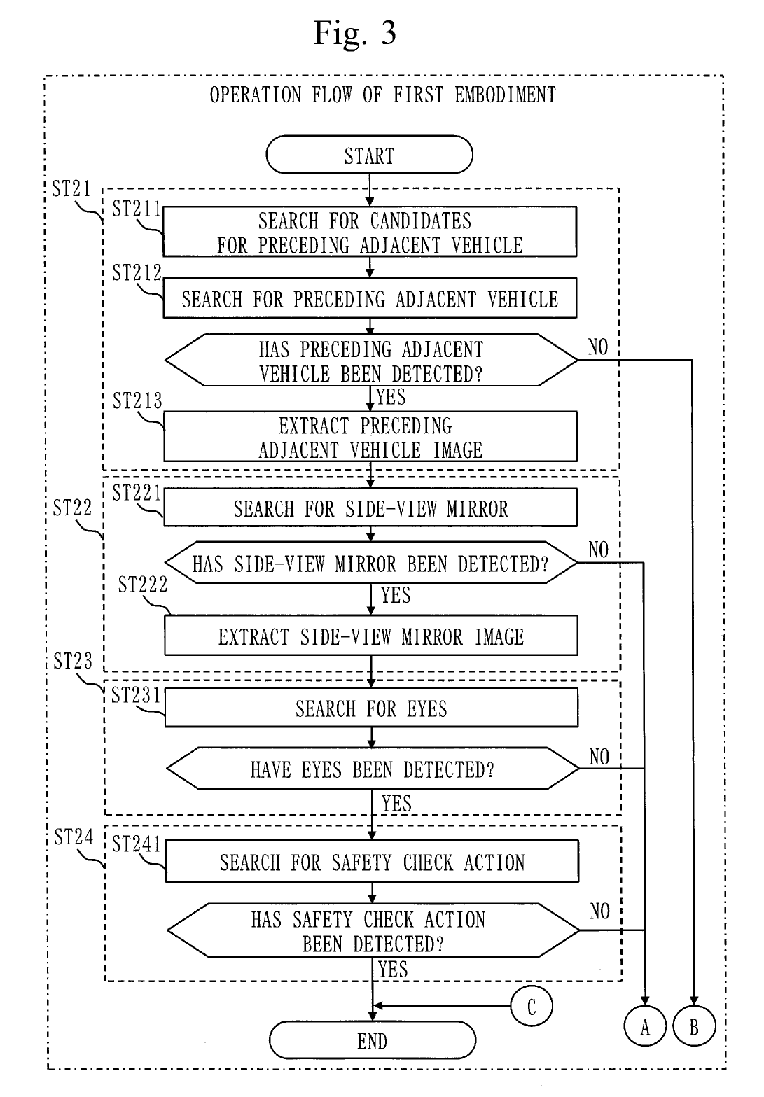

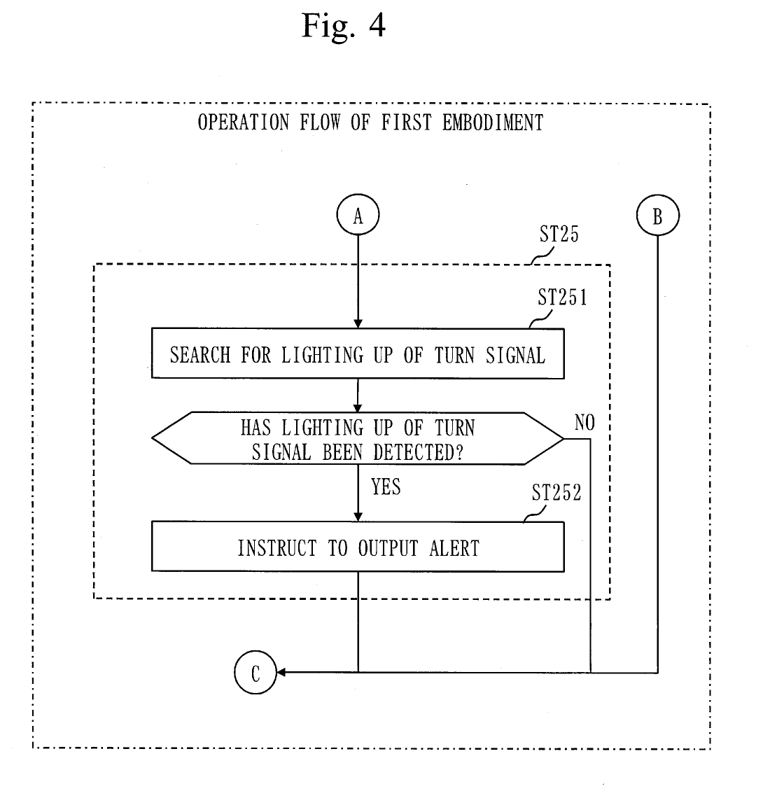

Next, with reference to flowcharts of FIGS. 3 and 4, exemplary operation of the on-vehicle apparatus 10 according to the present embodiment will be described. Note that the flow of FIGS. 3 and 4 is repeated in a certain cycle.

Step ST21 is performed by the vehicle detecting unit 21.

First, the vehicle detecting unit 21 searches a photographed image of the camera 13 for candidates for a preceding adjacent vehicle (step ST211). Then, the vehicle detecting unit 21 searches for a preceding adjacent vehicle from among the candidates for a preceding adjacent vehicle (step ST212). If a preceding adjacent vehicle has not been able to be detected, the on-vehicle apparatus 10 ends the process. If a preceding adjacent vehicle has been able to be detected, the vehicle detecting unit 21 extracts an image showing the preceding adjacent vehicle (hereinafter, the image showing the preceding adjacent vehicle is referred to as a preceding adjacent vehicle image) (step ST213). In addition, the vehicle detecting unit 21 outputs the preceding adjacent vehicle image to the side-view mirror detecting unit 22.

Step ST22 is performed by the side-view mirror detecting unit 22.

First, the side-view mirror detecting unit 22 searches the preceding adjacent vehicle image extracted at step ST213 for a side-view mirror (step ST221). If a side-view mirror has not been able to be detected, step ST25 is performed. Note that in this case the side-view mirror detecting unit 22 notifies the turn signal detecting unit 25 that a side-view mirror has not been able to be detected. If a side-view mirror has been able to be detected, the side-view mirror detecting unit 22 extracts an image in which a region showing the side-view mirror of the preceding adjacent vehicle is extracted (hereinafter, the image showing the side-view mirror of the preceding adjacent vehicle is referred to as a side-view mirror image) (step ST222). In addition, the side-view mirror detecting unit 22 outputs the side-view mirror image to the field-of-vision determining unit 23.

Step ST23 is performed by the field-of-vision determining unit 23.

First, the field-of-vision determining unit 23 searches the side-view mirror image extracted at step ST222 for the eyes of a driver of the preceding adjacent vehicle (step ST231). If the eyes of the driver of the preceding adjacent vehicle have not been able to be detected, step ST25 is performed. Note that in this case the field-of-vision determining unit 23 notifies the turn signal detecting unit 25 that the eyes of the driver of the preceding adjacent vehicle have not been able to be detected. On the other hand, if the eyes of the driver of the preceding adjacent vehicle have been able to be detected, step ST24 is performed. In addition, the field-of-vision determining unit 23 notifies the safety check action detecting unit 24 that the eyes of the driver of the preceding adjacent vehicle have been able to be detected in the side-view mirror.

Step ST24 is performed by the safety check action detecting unit 24.

First, the safety check action detecting unit 24 searches for safety check action (step ST241). That is, the safety check action detecting unit 24 monitors the side-view mirror image to determine whether the eyes of the driver of the preceding adjacent vehicle are directed to a side-view mirror on the side of the travel lane for the vehicle 1, i.e., whether the driver of the preceding adjacent vehicle has performed side and rear safety checks by looking at the side-view mirror. If the safety check action detecting unit 24 has not been able to detect safety check action by the driver of the preceding adjacent vehicle, step ST25 is performed. Note that in this case the safety check action detecting unit 24 notifies the turn signal detecting unit 25 that safety check action has not been able to be detected. On the other hand, if safety check action has been able to be detected, the on-vehicle apparatus 10 terminates the operation.

Step ST25 is performed by the turn signal detecting unit 25.

The turn signal detecting unit 25 performs step ST25 in any of the case in which the turn signal detecting unit 25 is notified by the side-view mirror detecting unit 22 that a side-view mirror has not been able to be detected, the case in which the turn signal detecting unit 25 is notified by the field-of-vision determining unit 23 that the eyes of the driver of the preceding adjacent vehicle have not been able to be detected, and the case in which the turn signal detecting unit 25 is notified by the safety check action detecting unit 24 that safety check action by the driver of the preceding adjacent vehicle has not been able to be detected.

First, the turn signal detecting unit 25 searches the preceding adjacent vehicle image for the lighting up of a turn signal on the side of the travel lane for the vehicle 1 among turn signals of the preceding adjacent vehicle (step ST251). If the lighting up of the turn signal has not been detected, the on-vehicle apparatus 10 terminates the operation. On the other hand, if the lighting up of the turn signal has been detected, the turn signal detecting unit 25 instructs the alert output unit 26 to output an alert (step ST252).

As described previously, the alert output unit 26 outputs an alert to the speaker 14 or the display 15 or the speaker 14 and the display 15, in response to the instruction from the turn signal detecting unit 25.

Description of an Advantageous Effect of the Embodiment

As described above, in the present embodiment, the camera 13 mounted on the vehicle 1 photographs a side-view mirror of a preceding adjacent vehicle. Then, the on-vehicle apparatus 10 detects the eyes of a driver of the preceding adjacent vehicle, and determines whether the vehicle 1 is present in the field of vision of the driver of the preceding adjacent vehicle. Furthermore, the on-vehicle apparatus 10 detects safety check action by the driver of the preceding adjacent vehicle, by detecting the movement of the eyes of the driver of the preceding adjacent vehicle. Furthermore, the on-vehicle apparatus 10 detects the intention of the driver of the preceding adjacent vehicle for a lane change, by detecting the lighting up of a turn signal of the preceding adjacent vehicle. If the driver of the preceding adjacent vehicle has not performed a safety check despite the driver of the preceding adjacent vehicle having an intention for a lane change, the on-vehicle apparatus 10 informs a driver of the vehicle 1 about a hazard.

Therefore, according to the present embodiment, the driver of the vehicle 1 can be warned of the possibility of a collision with a preceding adjacent vehicle due to a lane change by the preceding adjacent vehicle, without depending on a device mounted on the preceding adjacent vehicle. Then, by this, a collision between the vehicle 1 and the preceding adjacent vehicle can be avoided.

### Second Embodiment

In the first embodiment, when safety check action has been detected, a turn signal lighting-up detection process is not performed; however, in a second embodiment, even when safety check action has been detected, a turn signal lighting-up detection process is performed.

In general, when a lane change is made, a driver checks side and rear safety. Hence, when safety check action by a driver of a preceding adjacent vehicle has been detected, it is considered that the driver of the preceding adjacent vehicle has an intention for a lane change. In a case in which the lighting up of a turn signal of the preceding adjacent vehicle has not been able to be detected when safety check action by the driver of the preceding adjacent vehicle has been detected, it is considered that the driver of the preceding adjacent vehicle has forgotten to light up the turn signal despite his/her intention for a lane change.

Hence, when the lighting up of a turn signal has not been detected despite the fact that safety check action by the driver of the preceding adjacent vehicle has been detected, an on-vehicle apparatus 10 according to the present embodiment warns the driver of the vehicle 1 of a risk of a collision.

Description of Configuration

An exemplary hardware configuration and an exemplary functional configuration of the on-vehicle apparatus 10 according to the second embodiment are the same as those of the first embodiment. Note, however, that in the present embodiment, when the monitoring unit 20 does not detect the lighting up of a turn signal that gives notice of a lane change to the travel lane after detecting safety check action for a lane change to the travel lane by a driver of a preceding adjacent vehicle, the monitoring unit 20 instructs the alert output unit 26 to output an alert.

Description of Operation

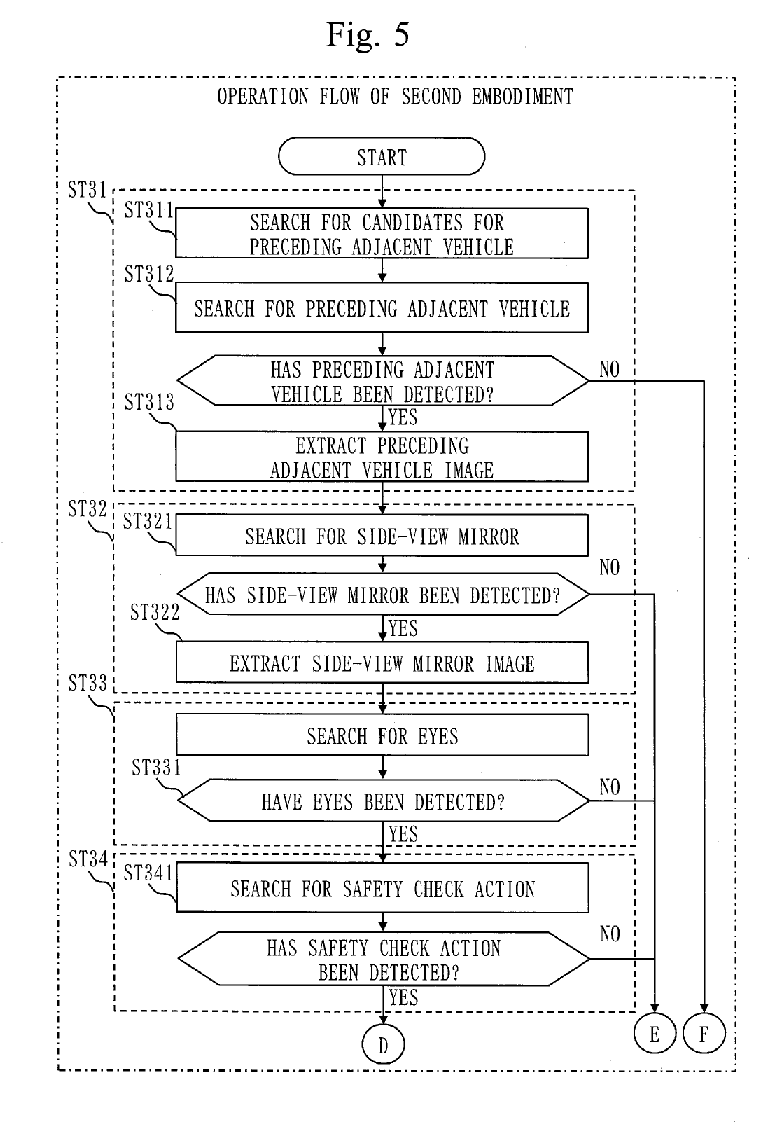

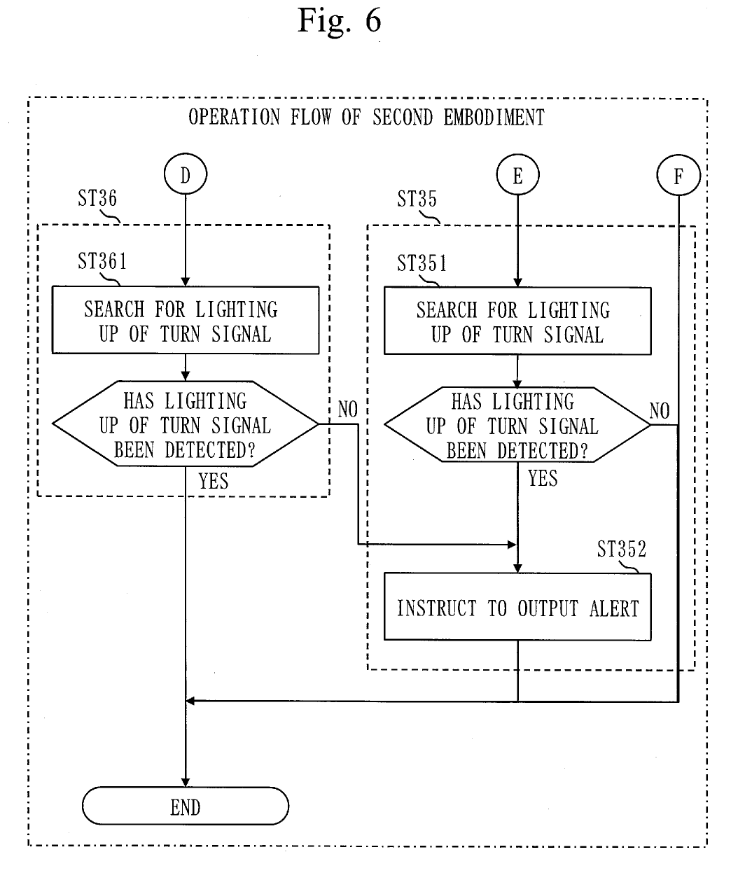

An operation flow of the on-vehicle apparatus 10 according to the second embodiment is illustrated in FIGS. 5 and 6.

Step ST31 to ST33 illustrated in FIG. 5 are the same as step S21 to ST23 illustrated in FIG. 3 and thus description thereof is omitted.

If the safety check action detecting unit 24 cannot detect safety check action by a driver of a preceding adjacent vehicle at step ST34, step ST35 is performed. In this case, the safety check action detecting unit 24 notifies the turn signal detecting unit 25 that safety check action has not been able to be detected. On the other hand, if the safety check action detecting unit 24 has been able to detect safety check action, step ST36 is performed. In this case, the safety check action detecting unit 24 notifies the turn signal detecting unit 25 that safety check action has been able to be detected.

Step ST35 is the same as step ST25 of FIG. 4 and thus description thereof is omitted.

Step ST36 is performed by the turn signal detecting unit 25.

First, the turn signal detecting unit 25 searches for the lighting up of a turn signal on the side of the travel lane for the vehicle 1 among turn signals of the preceding adjacent vehicle (step ST361). If the lighting up of the turn signal has not been detected, the turn signal detecting unit 25 proceeds to step S352 and instructs the alert output unit 26 to output an alert. On the other hand, if the lighting up of the turn signal has been detected, the on-vehicle apparatus 10 terminates the operation.

Description of an Advantageous Effect of the Embodiment

As described above, in the present embodiment, when a driver of a preceding adjacent vehicle forgets to light up a turn signal upon a lane change, too, a warning is given to the driver of the vehicle 1. Thus, a collision between the vehicle 1 and the preceding adjacent vehicle can be avoided.

### Third Embodiment

In the first and second embodiments, when the on-vehicle apparatus 10 cannot detect the eyes of a driver of a preceding adjacent vehicle, the on-vehicle apparatus 10 determines that the driver of the preceding adjacent vehicle cannot visually recognize the vehicle 1. Even if the eyes of the driver of the preceding adjacent vehicle cannot be detected in a photographed image of the camera 13, if the eyes of the driver of the preceding adjacent vehicle can be detected from a different position of the vehicle 1, then it is considered that the driver of the preceding adjacent vehicle can visually recognize the vehicle 1.

Hence, in the present embodiment, a plurality of cameras 13 that detect a preceding adjacent vehicle are disposed on a plurality of different positions of the vehicle 1, and the eyes of a driver of the preceding adjacent vehicle are detected by image analysis performed on a plurality of photographed images of the plurality of cameras 13.

Description of Configuration

An exemplary hardware configuration of an on-vehicle apparatus 10 according to the third embodiment is the same as that of the first embodiment. Note, however, that in the present embodiment, the number of cameras 13 is increased, and thus, the placement positions of the cameras 13 differ from that of the first embodiment. Since it is desirable to sense the eyes of a driver of a preceding adjacent vehicle from various positions of the vehicle 1, it is desirable that the placement positions of the cameras 13 be apart from each other. For example, when four cameras 13 are placed, it is desirable to place the cameras 13 on the left and right ends of a front bumper and a rear bumper of the vehicle 1.

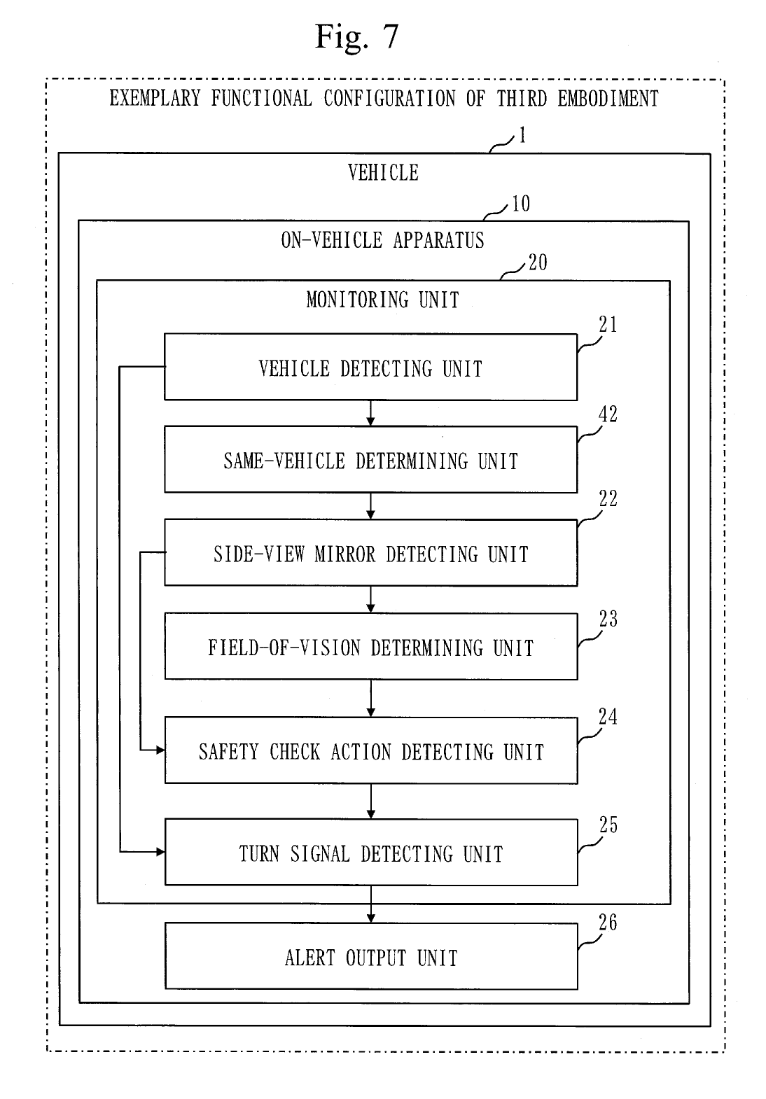

FIG. 7 illustrates an exemplary functional configuration of the on-vehicle apparatus 10 according to the present embodiment.

In FIG. 7, a same-vehicle determining unit 42 is added to the functional configuration illustrated in FIG. 2.

The same-vehicle determining unit 42 determines whether preceding adjacent vehicles detected in a plurality of photographed images of the plurality of cameras 13 are the same vehicle. A determination technique may be any technique for determining the sameness of objects shown in images, and any publicly known technique can be used. Specifically, the same-vehicle determining unit 42 can use a pattern matching method.

In the present embodiment, too, the field-of-vision determining unit 23 determines whether the vehicle 1 is present in the field of vision of a driver of a preceding adjacent vehicle. In the first embodiment, the field-of-vision determining unit 23 determines that the vehicle 1 is present in the field of vision of the driver of the preceding adjacent vehicle, when the field-of-vision determining unit 23 has been able to detect the eyes of the driver of the preceding adjacent vehicle in a photographed image of a single camera 13. The field-of-vision determining unit 23 according to the present embodiment determines that the vehicle 1 is present in the field of vision of the driver of the preceding adjacent vehicle, when the field-of-vision determining unit 23 has been able to detect the eyes of a driver of the same preceding adjacent vehicle in a specified number or more of photographed images by analyzing a plurality of photographed images of the plurality of cameras 13. The specified number may be arbitrarily set between 1 and n (n is the total number of cameras 13 placed on the vehicle 1). The larger the specified number, the harder it is to determine that the driver of the preceding adjacent vehicle visually recognizes the vehicle 1.

As described above, in the present embodiment, the monitoring unit 20 selects photographed images showing a preceding adjacent vehicle from among a plurality of photographed images obtained by the plurality of cameras 13 mounted on a plurality of positions of the vehicle 1, and determines whether the eyes of a driver of the preceding adjacent vehicle are reflected in a side-view mirror closer to the travel lane in the selected photographed images. Then, when the monitoring unit 20 has detected the lighting up of a turn signal that gives notice of a lane change to the travel lane, with the number of photographed images in which the eyes of the driver of the preceding adjacent vehicle are reflected in the side-view mirror being less than the specified number, the monitoring unit 20 instructs the alert output unit 26 to output an alert.

In addition, when the number of photographed images in which the eyes of the driver of the preceding adjacent vehicle are reflected in the side-view mirror is greater than or equal to the specified number, the monitoring unit 20 monitors the action of the driver of the preceding adjacent vehicle, using the plurality of photographed images obtained by the plurality of cameras 13 mounted on a plurality of positions of the vehicle 1.

Description of Operation

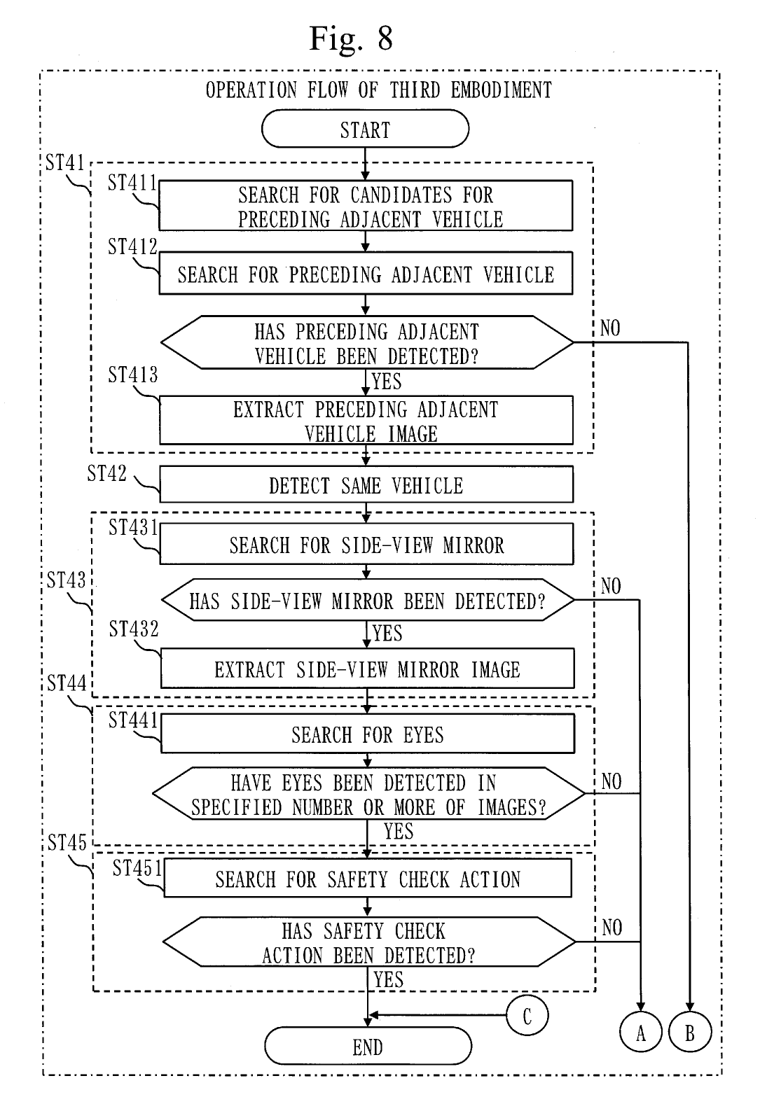

An operation flow of the on-vehicle apparatus 10 of the third embodiment is illustrated in FIG. 8. In FIG. 8, comparing with FIG. 3, step ST42 is added, and at step ST44, a criterion for detection of eyes is changed from step ST23.

Step ST41 is the same as step ST21 of FIG. 3, but the vehicle detecting unit 21 extracts a preceding adjacent vehicle image from each of a plurality of photographed images from the plurality of cameras 13. Then, the vehicle detecting unit 21 outputs the extracted plurality of preceding adjacent images to the same-vehicle determining unit 42.

Step ST42 is performed by the same-vehicle determining unit 42.

The same-vehicle determining unit 42 determines whether preceding adjacent vehicles shown in the plurality of photographed images of the plurality of cameras 13 are the same vehicle. That is, the same-vehicle determining unit 42 extracts preceding adjacent vehicle images showing the same preceding adjacent vehicle from among the plurality of preceding adjacent vehicle images obtained from the vehicle detecting unit 21. Then, the same-vehicle determining unit 42 outputs the extracted preceding adjacent vehicle images (the preceding adjacent vehicle images showing the same preceding adjacent vehicle) to the side-view mirror detecting unit 22.

Step ST43 is the same as step ST22 of FIG. 3, but the side-view mirror detecting unit 22 extracts a side-view mirror image from each of the preceding adjacent vehicle images obtained from the same-vehicle determining unit 42.

Step ST44 is performed by the field-of-vision determining unit 23.

The field-of-vision determining unit 23 searches the side-view mirror images extracted at step ST432 for the eyes of a driver of the preceding adjacent vehicle (step ST441). If the eyes of the driver of the preceding adjacent vehicle have been able to be detected in a specified number or more of side-view mirror images of the same preceding adjacent vehicle, step ST45 is performed. If the eyes of the driver of the preceding adjacent vehicle have not been able to be detected in the specified number or more of side-view mirror images of the same preceding adjacent vehicle, a process at step ST25 of FIG. 4 is performed. Note that in this case the field-of-vision determining unit 23 notifies the turn signal detecting unit 25 that the eyes of the driver of the preceding adjacent vehicle have not been able to be detected.

Step ST45 is the same as step ST24 of FIG. 3, but in a case in which there are a plurality of side-view mirror images, the safety check action detecting unit 24 determines that safety check action by the driver of the preceding adjacent vehicle has been detected, when the eyes of the driver of the preceding adjacent vehicle are directed to a side-view mirror in any one of the side-view mirror images.

Description of an Advantageous Effect of the Embodiment

As described above, in the present embodiment, photographed images of the plurality of cameras 13 disposed in a plurality of different positions are used, and thus, undetected safety check action by a driver of a preceding adjacent vehicle can be reduced.

### Fourth Embodiment

In the first to third embodiments, it is premised that a driver of a preceding adjacent vehicle takes safety check action using a side-view mirror. However, when the vehicle 1 is present in a blind spot of the side-view mirror of the preceding adjacent vehicle, the driver of the preceding adjacent vehicle visually recognizes the vehicle 1 by a visual check.

Hence, in the present embodiment, in addition to detection of safety check action by a driver of a preceding adjacent vehicle, using a side-view mirror image, visual safety check action by the driver of the preceding adjacent vehicle is detected by analyzing an image of the driver in a preceding adjacent vehicle image.

Description of Configuration

An exemplary hardware configuration of an on-vehicle apparatus 10 according to the fourth embodiment is the same as that of the first embodiment. That is, in the present embodiment, as in the first embodiment, there is one camera 13.

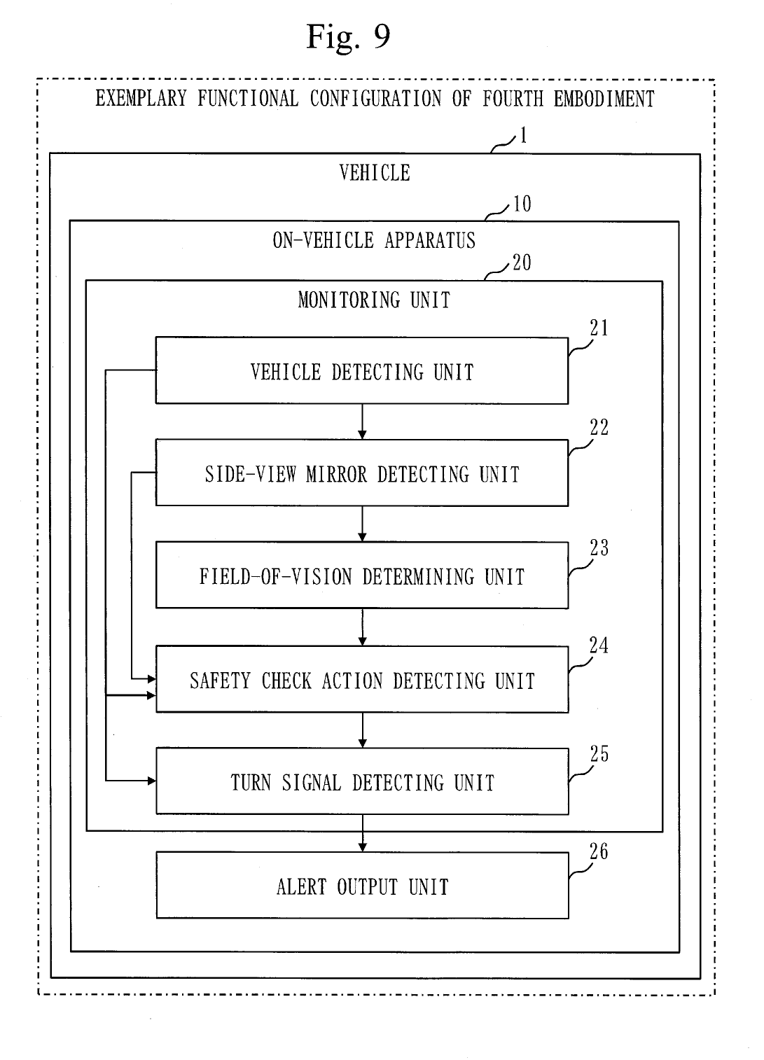

FIG. 9 illustrates an exemplary functional configuration of the on-vehicle apparatus 10 according to the fourth embodiment. Although the components themselves are the same as those illustrated in FIG. 2, in the present embodiment, as illustrated in FIG. 9, a preceding adjacent vehicle image is also outputted to the safety check action detecting unit 24 from the vehicle detecting unit 21.

Further, the safety check action detecting unit 24 detects visual safety check action by a driver of a preceding adjacent vehicle by analyzing an image of the driver in the preceding adjacent vehicle image obtained from the vehicle detecting unit 21, in addition to detection of safety check action by the driver of the preceding adjacent vehicle, using a side-view mirror image.

As described above, in the present embodiment, when a driver of a preceding adjacent vehicle shown in a photographed image has taken action to see the vehicle 1, the monitoring unit 20 determines that the driver of the preceding adjacent vehicle has taken safety check action for a lane change to the travel lane.

Description of Operation

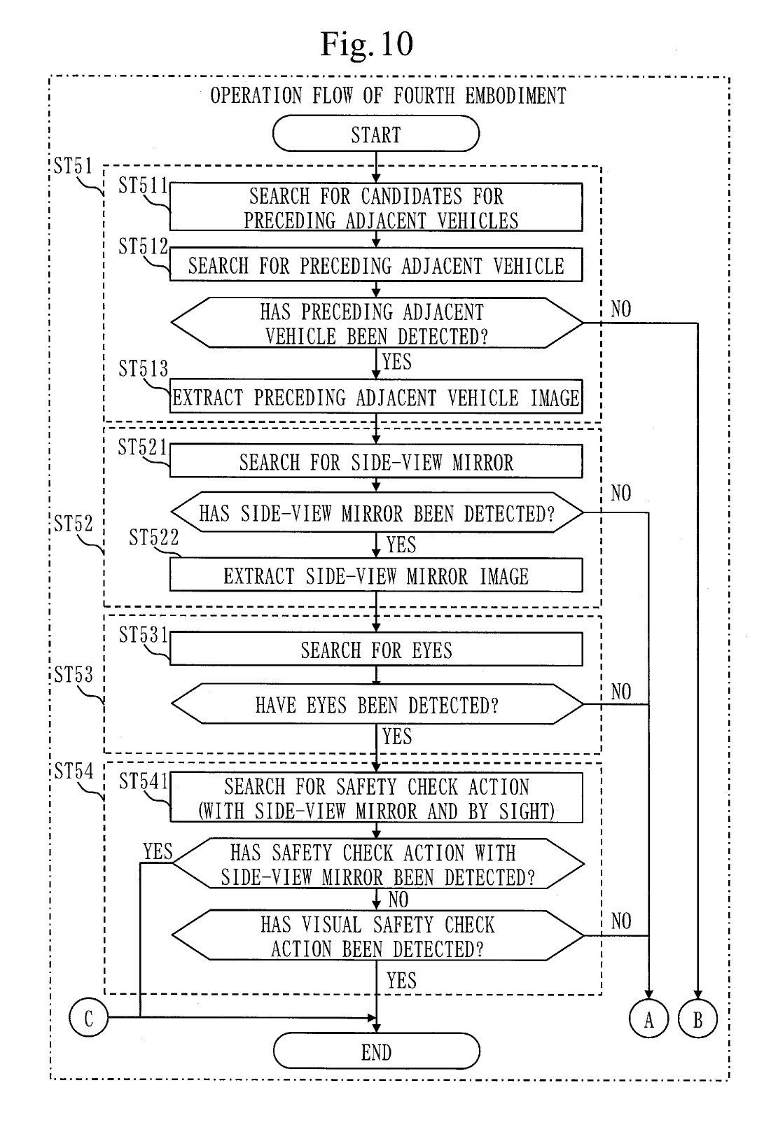

An operation flow of the fourth embodiment is illustrated in FIG. 10.

Step ST51 to ST53 illustrated in FIG. 10 are the same as step ST21 to ST23 illustrated in FIG. 3 and thus description thereof is omitted.

Step ST54 is performed by the safety check action detecting unit 24.

In the present embodiment, the safety check action detecting unit 24 searches for safety check action with a side-view mirror and visual safety check action (step ST541). That is, as in the first embodiment, the safety check action detecting unit 24 monitors a side-view mirror image to determine whether the eyes of a driver of a preceding adjacent vehicle are directed to a side-view mirror. Furthermore, the safety check action detecting unit 24 monitors an image of the driver in a preceding adjacent vehicle image obtained from the vehicle detecting unit 21, to determine whether the driver of the preceding adjacent vehicle has performed side and rear safety checks by sight.

If the safety check action detecting unit 24 has not been able to detect either safety check action with a side-view mirror or visual safety check action, the operation at step ST25 of FIG. 4 is performed. In the present embodiment, too, the safety check action detecting unit 24 notifies the turn signal detecting unit 25 that safety check action has not been able to be detected. On the other hand, if the safety check action detecting unit 24 has been able to detect safety check action with a side-view mirror or visual safety check action, the on-vehicle apparatus 10 terminates the operation.

Description of an Advantageous Effect of the Embodiment

As described above, in the present embodiment, when a driver of a preceding adjacent vehicle performs a visual safety check, an alert is not outputted, and thus, unnecessary alert output can be avoided.

Additional Notes

Although the embodiments of the present invention have been described above, two or more of the embodiments may be combined and implemented.

Alternatively, one of the embodiments may be partially implemented.

Alternatively, two or more of the embodiments may be partially combined and implemented.

Note that the present invention is not limited to the embodiments and various changes can be made as necessary.

Description of Hardware Configuration

Finally, supplemental remarks on the hardware configuration of the on-vehicle apparatus 10 will be made.

The processor 11 illustrated in FIG. 1 is an integrated circuit (IC) that performs processing.

The processor 11 is a central processing unit (CPU), a digital signal processor (DSP), and the like.

The memory 12 illustrated in FIG. 1 is a random access memory (RAM), a read only memory (ROM), a flash memory, a hard disk drive (HDD), and the like.

The memory 12 also stores therein an operating system (OS) in addition to the programs that implement the monitoring unit 20 and the alert output unit 26.

Then, at least a part of the OS is executed by the processor 11.

The processor 11 executes the programs that implement the functions of the monitoring unit 20 and the alert output unit 26 while executing at least a part of the OS.

Although FIG. 1 illustrates one processor, the on-vehicle apparatus 10 may include a plurality of processors.

In addition, information, data, signal values, and variable values that indicate processing results of the monitoring unit 20 and the alert output unit 26 are stored in the memory 12 or a register in the processor 11 or a cache memory.

In addition, the programs that implement the functions of the monitoring unit 20 and the alert output unit 26 may be stored in a portable storage medium such as a magnetic disk, a flexible disk, an optical disc, a compact disc, a Blu-ray (registered trademark) Disc, or a DVD.

In addition, the term “unit” of the monitoring unit 20 and the alert output unit 26 may be read as a “circuit” a “step”, a “procedure”, or a “process”.

In addition, the on-vehicle apparatus 10 may be implemented by an electronic circuit such as a logic integrated circuit (IC), a gate array (GA), an application specific integrated circuit (ASIC), or a field-programmable gate array (FPGA).

In this case, the monitoring unit 20 and the alert output unit 26 each are implemented as a part of the electronic circuit.

Note that the processor and the above-described electronic circuit are also collectively referred to as processing circuitry.

### REFERENCE SIGNS LIST

1: vehicle, 10: on-vehicle apparatus, 11: processor, 12: memory, 13: camera, 14: speaker, 15: display, 20: monitoring unit, 21: vehicle detecting unit, 22: side-view mirror detecting unit, 23: field-of-vision determining unit, 24: safety check action detecting unit, 25: turn signal detecting unit, 26: alert output unit, and 42: same-vehicle determining unit

1. An on-vehicle apparatus mounted on a vehicle, the on-vehicle apparatus comprising:
a monitoring circuit to monitor action of a driver of a preceding adjacent vehicle and a lighting-up state of a turn signal of the preceding adjacent vehicle, using a photographed image showing the preceding adjacent vehicle, and instruct to output an alert to a driver of the vehicle, when detecting lighting up of the turn signal without detecting the driver of the preceding adjacent vehicle taking safety check action for a lane change to a travel lane, the preceding adjacent vehicle traveling preceding the vehicle in a same direction as a travel direction of the vehicle and in a lane adjacent to the travel lane, the travel lane being a lane in which the vehicle is traveling, and the lighting up of the turn signal giving notice of a lane change to the travel lane; and
an alert output circuit to output the alert based on an instruction from the monitoring circuit.

2. The on-vehicle apparatus according to claim 1, wherein the monitoring circuit instructs the alert output circuit to output the alert, when the monitoring circuit does not detect lighting up of the turn signal after detecting safety check action for a lane change to the travel lane by the driver of the preceding adjacent vehicle, the lighting up of the turn signal giving notice of a lane change to the travel lane.

3. The on-vehicle apparatus according to claim 1, wherein the monitoring circuit determines whether eyes of the driver of the preceding adjacent vehicle are reflected in a side-view mirror of the preceding adjacent vehicle shown in the photographed image, and instructs the alert output circuit to output the alert when the monitoring circuit detects lighting up of the turn signal with the eyes of the driver of the preceding adjacent vehicle not reflected in the side-view mirror, the side-view mirror being closer to the travel lane, and the lighting up of the turn signal giving notice of a lane change to the travel lane.

4. The on-vehicle apparatus according to claim 3, wherein the monitoring circuit determines whether the driver of the preceding adjacent vehicle has taken safety check action for a lane change to the travel lane, by analyzing movement of the eyes of the driver of the preceding adjacent vehicle reflected in the side-view mirror, with the eyes of the driver of the preceding adjacent vehicle reflected in the side-view mirror.

5. The on-vehicle apparatus according to claim 4, wherein the monitoring circuit determines that the driver of the preceding adjacent vehicle has taken safety check action for a lane change to the travel lane, when the monitoring circuit detects that the eyes of the driver of the preceding adjacent vehicle has been directed to the side-view mirror, by analyzing the movement of the eyes of the driver of the preceding adjacent vehicle reflected in the side-view mirror.

6. The on-vehicle apparatus according to claim 4, wherein the monitoring circuit determines that the driver of the preceding adjacent vehicle has taken safety check action for a lane change to the travel lane, when the monitoring circuit detects that the driver of the preceding adjacent vehicle shown in the photographed image has taken action to see the vehicle.

7. The on-vehicle apparatus according to claim 1, wherein the monitoring circuit monitors action of the driver of the preceding adjacent vehicle, using a plurality of photographed images obtained by a plurality of cameras mounted on a plurality of positions of the vehicle.

8. The on-vehicle apparatus according to claim 1, wherein the monitoring circuit selects photographed images showing the preceding adjacent vehicle from among a plurality of photographed images obtained by a plurality of cameras mounted on a plurality of positions of the vehicle, determines whether eyes of the driver of the preceding adjacent vehicle are reflected in a side-view mirror closer to the travel lane in the selected photographed images, and instructs the alert output circuit to output the alert when the monitoring circuit detects lighting up of the turn signal with a number of photographed images in which the eyes of the driver of the preceding adjacent vehicle are reflected in the side-view mirror being less than a specified number, the lighting up of the turn signal giving notice of a lane change to the travel lane.

9. An alert output method performed on a vehicle, the alert output method comprising:
monitoring, action of a driver of a preceding adjacent vehicle and a lighting-up state of a turn signal of the preceding adjacent vehicle, using a photographed image showing the preceding adjacent vehicle, the preceding adjacent vehicle traveling preceding the vehicle in a same direction as a travel direction of the vehicle and in a lane adjacent to a travel lane, and the travel lane being a lane in which the vehicle is traveling; and
outputting, an alert to a driver of the vehicle, when the computer detects lighting up of the turn signal without detecting the driver of the preceding adjacent vehicle taking safety check action for a lane change to the travel lane, the lighting up of the turn signal giving notice of a lane change to the travel lane.

10. A non-transitory computer readable medium storing an alert output program causing a computer mounted on a vehicle to:
monitor action of a driver of a preceding adjacent vehicle and a lighting-up state of a turn signal of the preceding adjacent vehicle, using a photographed image showing the preceding adjacent vehicle, the preceding adjacent vehicle traveling preceding the vehicle in a same direction as a travel direction of the vehicle and in a lane adjacent to a travel lane, and the travel lane being a lane in which the vehicle is traveling; and
output an alert to a driver of the vehicle, when the computer detects lighting up of the turn signal without detecting the driver of the preceding adjacent vehicle taking safety check action for a lane change to the travel lane, the lighting up of the turn signal giving notice of a lane change to the travel lane.
